(19) United States
(12) Patent Application Publication
(10) Pub. No.: US 2013/0128951 A1
(43) Pub. Date: May 23, 2013

(54) METHOD AND APPARATUS FOR DECODING CONTENT USING DECODING INFORMATION

(71) Applicants: Soo-min SHIN, Suwon-si (KR); Young-chul SOHN, Seoul (KR)

(72) Inventors: Soo-min SHIN, Suwon-si (KR); Young-chul SOHN, Seoul (KR)

(73) Assignee: SAMSUNG ELECTRONICS CO., LTD., Suwon-si (KR)

(21) Appl. No.: 13/564,789

(22) Filed: Aug. 2, 2012

(30) Foreign Application Priority Data
Nov. 17, 2011 (KR) 10-2011-0120325

(51) Int. Cl. H04N 7/26

(52) U.S. Cl. 375/240.02; 375/E07.027

(57) ABSTRACT

Provided are an apparatus and method for decoding content data by using decoding information. The method includes: receiving a content switch requesting signal; receiving new content requested by the content switch requesting signal; extracting decoding information from the new content data; comparing the decoding information of the new content data to decoding information of previous content data; and, based on a result of the comparing the decoding information of the new content data to the decoding information of the previous content data, determining whether to stop a decoder.

### CROSS-REFERENCE TO RELATED PATENT APPLICATION

This application claims priority from Korean Patent Application No. 10-2011-0120325, filed on Nov. 17, 2011 in the Korean Intellectual Property Office, the disclosure of which is incorporated herein in its entirety by reference.

### BACKGROUND

1. Field

Apparatuses and methods consistent with exemplary embodiments relate to decoding content data at digital broadcasting channel and a terminal for reproducing streamed content.

2. Description of the Related Art

In the related art, while switching a broadcasting channel or a content to another broadcasting channel or another content, decoding information regarding data to be decoded may vary from one channel or content to another. As a result, a decoder is always restarted in order to prevent a decoding error. Therefore, since a decoder is restarted every time a channel or a content is switched, delay for restarting the decoder is inevitable.

### SUMMARY

Aspects of exemplary embodiments provide a method and an apparatus for decoding content data by using decoding information.

According to an aspect of another exemplary embodiment, there is provided a method of decoding content data by using decoding information, the method including: receiving a content switch requesting signal; receiving new content requested by the content switch requesting signal; extracting decoding information from the new content data; comparing the decoding information of the new content data to decoding information of previous content data; and based on a result of the comparing the decoding information of the new content data to the decoding information of the previous content data, determining whether to stop a decoder.

The method may further include: if the decoding information of the new content data is identical to the decoding information of the previous content data, decoding the new content data without restarting the decoder; and, if the decoding information of the new content data is not identical to the decoding information of the previous content data, decoding the new content data after stopping and restarting the decoder.

In the step of receiving the new content data, the new content data may be received after data stored in a buffer in relation to the previous content data is deleted.

In the step of comparing the decoding information of the new content data to the decoding information of the previous content data, information used for comparing an identity of decoding information by which it is determined whether to stop and restart the decoder for switching contents may be compared.

In the step of extracting the decoding information of the new content data, after the decoding information of the new content data is extracted, the extracted decoding information of the new content data may be stored.

In the step of comparing the decoding information of the new content data to the decoding information of the previous content data, in a case of switching content, the decoding information of the new content data may be compared to the decoding information of the previous content data that is stored in advance.

In the step of extracting the decoding information of the new content data, at least one type of content data may be parsed from the content, and at least one decoding information may be extracted per type of content data.

In the step of comparing the decoding information of the new content data to the decoding information of the previous content data, the decoding information of the previous content data may be deleted after the decoding information of the new content data is compared to the decoding information of the previous content data.

According to an aspect of another exemplary embodiment, there is provided a computer readable recording medium having recorded thereon a computer program for implementing the method described above.

According to an aspect of another exemplary embodiment, there is provided a terminal device for decoding content data by using decoding information, the terminal device including: a content receiving unit which receives new content data; a content processing unit which includes a decoder for decoding content data and outputting the decoded content data to a content outputting unit, receives the new content data from the content receiving unit according to a request for switching content, compares decoding information of the new content data to decoding information of previous content data, and, based on a result of the comparing the decoding information of the new content data to the decoding information of the previous content data, determines whether to stop the decoder; and the content outputting unit, which outputs the decoded content data.

If the decoding information of the new content data is identical to the decoding information of the previous content data, the decoder may decode the new content data without being restarted, and, if the decoding information of the new content data is not identical to the decoding information of the previous content data, the decoder may decode the new content data after being stopped and restarted.

The decoder may include a decoding control unit which includes: a decoding information extracting module for extracting decoding information from the content data; a decoding information comparing module for comparing the decoding information of the new content data to the decoding information of the previous content data; and a decoding performing unit which performs decoding of the content data.

The decoder may further include a decoder storage unit which stores information used for comparing an identity of decoding information by which it is determined whether to stop and restart the decoder or not for switching contents, and the decoding information comparing module may compare decoding information including one or more information used for comparing an identity of decoding information by which it is determined whether to stop and restart he decoder or not for switching contents.

The decoder further may include a decoder storage unit, which stores decoding information of the content data, and, in a case of switching content, the decoding information comparing unit may compare the decoding information of the new content data to the decoding information of the previous content data that is stored in advance.

The decoding control unit may delete the decoding information of the previous content data after the decoding information of the new content data is compared to the decoding information of the previous content data.

When the decoding information of the new content data is extracted by the decoding information extracting module, the decoding control unit may store the decoding information of the new content data in the decoder storage unit.

The content processing unit may further include a buffer which temporarily stores content transmitted to the decoder, data related to the previous content data stored in the buffer may be deleted in response to the request for switching content, and the content receiving unit may receive the new content data.

The content processing unit may further include a demuxer which categorizes the content into various types of data, and the decoder may extract at least one decoding information per type of data and compares the decoding information of the previous content data to the decoding information of the new content data.

According to an aspect of another exemplary embodiment, there is provided a method of decoding content data by using decoding information, the method including: comparing first decoding information corresponding to new content data to second decoding information corresponding to previous content data; and based on a result of the comparing the first decoding information to the second decoding information, determining whether to restart a decoder when switching from an output of the previous content data to an output of the new content data.

### BRIEF DESCRIPTION OF THE DRAWINGS

The above and other features and advantages will become more apparent by describing in detail exemplary embodiments with reference to the attached drawings in which:

FIG. 1 is an outside block diagram of a terminal device for decoding content data by using decoding information, according to an exemplary embodiment;

FIGS. 2A and 2B are block diagrams of a terminal device which decodes content data by using decoding information, according to an exemplary embodiment;

FIG. 3 is a block diagram of a content processing unit of a terminal device which decodes content data by using decoding information, according to an exemplary embodiment;

FIG. 4 is a block diagram of a decoder of a terminal device which decodes content data by using decoding information, according to an exemplary embodiment; and

FIG. 5 is a flowchart of a method of decoding content data by using decoding information, according to an exemplary embodiment.

### DETAILED DESCRIPTION OF EXEMPLARY EMBODIMENTS

Exemplary embodiments will now be described more fully with reference to the accompanying drawings. In the description, if it is determined that a detailed description of commonly-used technologies or structures related to exemplary embodiments may unnecessarily obscure the subject matter, the detailed description will be omitted. Like numbers refer to like elements throughout.

Unless otherwise defined, all terms (including technical and scientific terms) used herein have the same meaning as commonly understood by one of ordinary skill in the art to which exemplary embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

FIG. 1 is an outside block diagram of a terminal device 1000 for decoding content data by using decoding information, according to an exemplary embodiment.

Referring to FIG. 1, the terminal device 1000 may provide content to a user by being connected to an external device, receiving content streamed via a digital broadcasting service or a network, and outputting the received content via an outputting unit.

The digital broadcasting service refers to a service for encoding video and audio signals to digital data and providing the digital data to user terminals via various transmission networks. For example, the digital broadcasting service may include a digital satellite broadcasting service, a digital cable broadcasting service, a digital terrestrial broadcasting service, a digital multimedia broadcasting (DMB) service, an Internet protocol television service, and any other equivalent services.

The terminal device 1000 be any of various user devices, such as a personal computer (PC), a laptop computer, a mobile phone, a tablet PC, a navigation device, a smart phone, a personal digital assistant (PDA), a smart TV, a portable multimedia player (PMP), a digital broadcasting receiver, etc. However, it is understood that the devices stated above are merely examples, and the terminal device 1000 includes any of various other communicable devices that are either currently developed and commercialized or to be developed in the future.

The terminal device 1000 provides content to a user by being connected to an external device, receiving the content streamed via a digital broadcasting or a network, and outputting the received content via an outputting unit. Here, when the terminal device 1000 stops decoding previous content data and starts decoding new content data, the terminal device 1000 determines whether to restart a decoder or not based on decoding information of each of the content data. Therefore, when decoding information of previous content data is identical to decoding information of new content data, the terminal 1000 decodes the new content without restarting the decoder. As a result, a period of time elapsed for restarting a decoder when switching content may be eliminated, and thus a delay for switching content may be minimized.

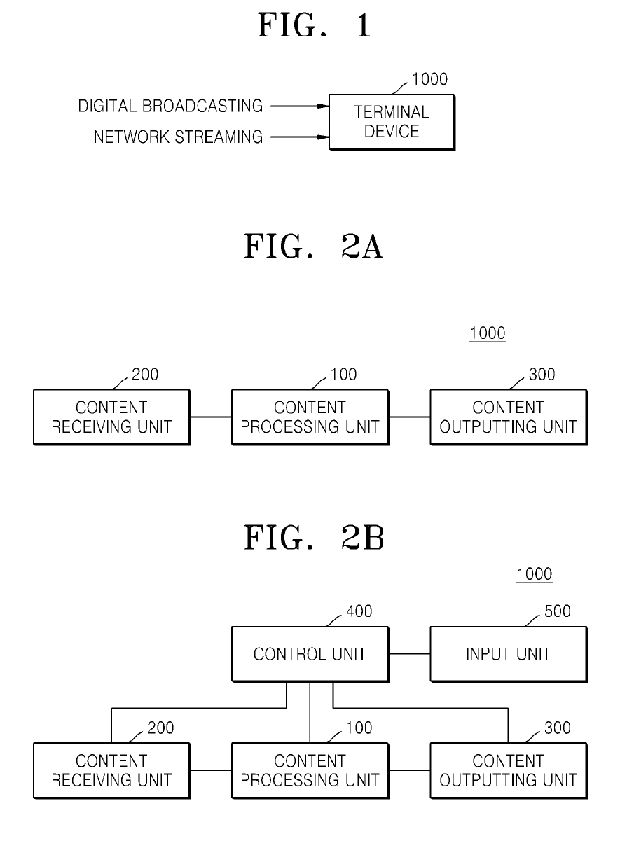

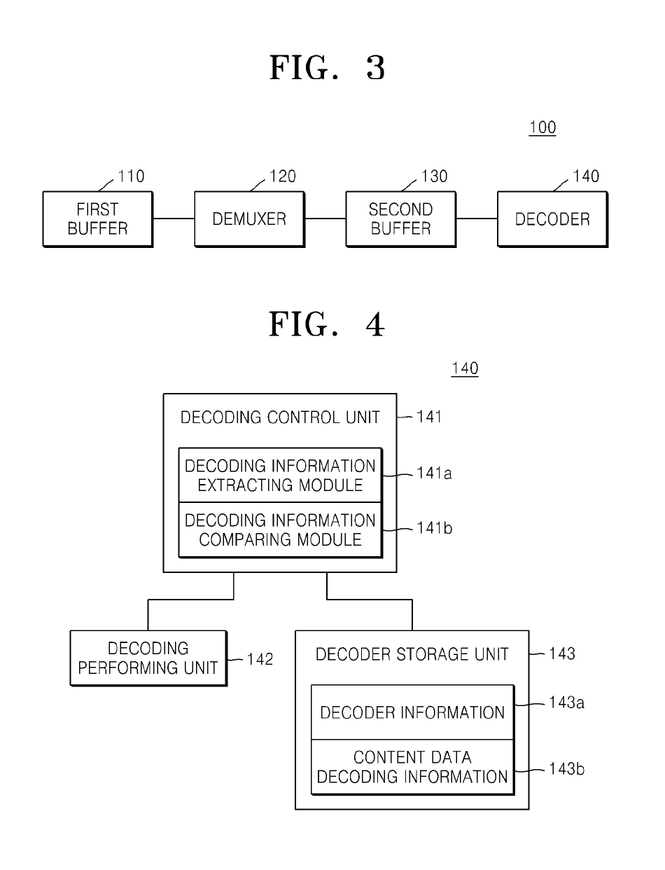

The content refers to content received by a content receiving unit 200 (see FIG. 2) or stored locally, and such content may be parsed to various types of content data via the demuxer 120 (see FIG. 3). Parsed content data is decoded by the decoder 140 (see FIG. 3). Furthermore, since decoding information may include decoding-related information, decoding information may exist in correspondence to each content data.

FIGS. 2A and 2B are block diagrams of a terminal device 1000 which decodes content data by using decoding information, according to an exemplary embodiment.

Referring to FIG. 2A, the terminal device 1000 may include a content receiving unit 200, a content processing unit 100, and a content outputting unit 300. Referring to FIG. 2B, the terminal device 1000 may further include a control unit 400 which controls overall operations of the terminal device 1000 and an input unit 500 which receives user inputs.

Referring to FIG. 2B, the terminal device 1000 may include the control unit 400, the input unit 500, the content receiving unit 200, the content processing unit 100, and the content outputting unit 300.

The control unit 400 controls overall operations of the terminal device 1000, operates based on an operating system (OS) stored in a storage space of the terminal device 1000 to establish a basic platform environment of the terminal device 1000, and provides arbitrary functions by executing application programs according to user selections. According to the present exemplary embodiment, the control unit 400 controls such that, to switch content or a digital broadcasting channel according to, for example, a user input signal or a program setting, the content receiving unit 200 receives new content, the content processing unit 100 processes the received new content, and the content outputting unit 300 outputs the new content.

The input unit 500 generates user input signals for controlling or operating the terminal device 1000 according to user inputs, and may be embodied as any of various input devices. For example, the input unit 500 may include one or more from among a key input device, a touch input device, a gesture input device, a voice input device, etc. The key input device is a device for generating signals corresponding to keys operated by a user, e.g., a keypad, a keyboard, etc. The touch input device is a device for recognizing input motions by detecting motions of a user touching particular locations, e.g., a touchpad, a touch screen, a touch sensor, etc. The gesture input device is a device for recognizing particular designated motions of a user, such as shaking or moving a device, approaching a device, blinking eyes, etc., as corresponding input signals and may include one or more from among a geomagnetic sensor, an acceleration sensor, a camera, an altimeter, a gyro sensor, a proximity sensor, etc.

The content receiving unit 200 receives content via a broadcasting network or a communication network according to a control signal received from the control unit 400. Next, the content receiving unit 200 may transmit received content to the content processing unit 100, so that content data processed by the content processing unit 100 may be output by the content outputting unit 300.

The content processing unit 100 processes content received from the content receiving unit 200 and transmits the processed content to the content outputting unit 300, so that the content may be output. A detailed description of the content processing unit 100 will be given below with reference to FIG. 3.

The content outputting unit 300 receives and outputs content data processed by the content processing unit 100. For example, the content outputting unit 300 may be any of a liquid crystal display (LCD), a thin film transistor liquid crystal display (TFT-LCD), a light emitting diodes (LED), an organic light emitting diodes (OLED), an active matrix organic light emitting diodes (AMOLED), a flexible display, and a three-dimensional (3D) display. However, it is understood that another exemplary embodiment is not limited to a terminal device 1000 including a display. For example, another exemplary embodiment may be directed to a terminal device 1000 that does not include a display, such as a set-top box, a stand-device, a receiver, etc., and that outputs the processed content data for display on an external display device.

FIG. 3 is a block diagram of a content processing unit 100 of a terminal device 1000 which decodes content data by using decoding information, according to an exemplary embodiment.

Referring to FIG. 3, the content processing unit 100 may include a first buffer 110, the demuxer 120, a second buffer 130, and the decoder 140.

The first buffer 110 and the second buffer 130 temporarily store content to be transmitted to the demuxer 120 and the decoder 140, respectively, and are arranged to handle a case in which a downloading rate of content received via the content receiving unit 200 is inconsistent due to conditions of a broadcasting network or a communication network. In other words, content may be stored in the buffers 110 and 130 when a downloading rate of the content is high, and the content stored in the buffers 110 and 130 may be processed when the downloading rate of the content is low. Therefore, quality of the content output by the content outputting unit 300 may be consistently maintained.

According to the present exemplary embodiment, the first buffer 110 temporarily stores content received by the content receiving unit 200, whereas the second buffer 130 temporarily stores content data parsed by the demuxer 120. Content stored in the first buffer 110 is transmitted to the demuxer 120 and parsed therefrom, and content data stored in the second buffer 130 is transmitted to the decoder 140 and decoded thereby.

Furthermore, when the content processing unit 100 receives a content switch requesting signal from the control unit 400, previous content and previous content data stored in the buffers 110 and 130 are deleted to process new content, and new content received by the content receiving unit 200 and new content data may be temporarily stored in the buffers 110 and 130.

The demuxer 120 parses content into content data and transmits the parsed content data to the decoder 140. In a case of motion picture content, for example, the demuxer 120 outputs a video stream and an audio stream. Content data parsed by the demuxer 120 is transmitted to the decoder 140.

The decoder 140 receives and processes content data parsed by the demuxer 120, so that the processed content data may be output by the content outputting unit 300.

Before decoding, the decoder 140 extracts decoding information regarding new content data and compares the decoding information regarding the new content data to decoding information regarding previous content data. If the decoding information regarding the new content data is identical to the decoding information regarding the previous content data, the decoder 140 is not restarted, and thus a delay for restarting the decoder 140 may be eliminated. On the other hand, if the decoding information regarding the new content data is not identical to the decoding information regarding the previous content data, the decoder 140 may be restarted and decode the new content data. A detailed description of the decoder 140 will be given below with reference to FIG. 4.

FIG. 4 is a block diagram of a decoder 140 of a terminal device 1000 which decodes content data by using decoding information, according to an exemplary embodiment.

The decoder 140 according to the present exemplary embodiment may include a decoding control unit 141, a decoding performing unit 142, and a decoder storage unit 143.

The decoding control unit 141 controls the overall operations of the decoder 140. According to the present exemplary embodiment, the decoding control unit 141 may include a decoding information extracting unit 141a which extracts decoding information regarding new content data, and a decoding information comparing unit 141b which compares decoding information of previous content data with decoding information of new content data.

When the decoding information comparing unit 141b compares decoding information of previous content data with decoding information of new content data, if the decoding information of the previous content data is identical to the decoding information of the new content data, the decoding control unit 141 does not restart the decoder 140. If the decoding information of the previous content data is not identical to the decoding information of the new content data, the decoding control unit 141 restarts the decoder 140.

The decoding performing unit 142 receives content data parsed by the demuxer 120 according to a control signal received from the decoding control unit 141 and decodes the content data, such that the content data may be output by the content outputting unit 300.

The decoder storage unit 143 stores at least one of data and programs used for operating the decoder 140 and may include any of various types of storage media, such as a random access memory (RAM), a read only memory (ROM), a hard disk drive (HDD), a flash memory, a CD-ROM, a DVD, etc. According to the present exemplary embodiment, the decoder storage unit 143 may store the decoder information 143a and the content data decoding information 143b together.

The content data decoding information 143b includes codec information used for decoding content data and various other information used for decoding content data, e.g., resolutions, frame rates, audio channels, etc. Such decoding information used for decoding content data may vary according to characteristics of each of decoders.

The decoder information 143a includes information regarding decoders related to decoding information. In some decoders, it may not be necessary to restart the decoders even if decoding information of new content data is not identical to decoding information of previous content data. Therefore, while decoding information of new content data is compared to decoding information of previous content data, the decoder 140 may refer to the decoder information 143a including a list of decoding information corresponding to cases where the decoder 140 is to be restarted if the decoding information of the new content data is not identical to the decoding information of the previous content data.

In detail, the decoding information comparing unit 141b of the decoding control unit 141 may refer to the decoder information 143a and select and compare decoding information of new content data and decoding information of previous content data, which correspond to decoding information included in a list of decoding information. Therefore, in this case, it is not necessary to compare all decoding information by using the decoder information 143a, and, even if decoding information of the new content data is partially identical to decoding information of the previous content data, it is not necessary to restart the decoder 140. Therefore, a number of cases where the decoder 140 is to be restarted may be minimized.

The decoder information 143a may vary according to specifications of the decoder 140 or installed programs that are used for operating the decoder 140 and may be stored in the decoder storage unit 143. Furthermore, in a case where the decoder information 143a may be modified as the programs are updated, the decoder information 143a may be updated based on related information received from other source devices.

The content data decoding information 143b includes decoding information extracted from content that is decoded by the decoder 140. By using the content data decoding information 143b, the decoding information comparing unit 141b may compare decoding information regarding previous content data to decoding information regarding new content data, or the content data decoding information 143b may be used when the decoding performing unit 142 decodes content.

In other words, decoding information regarding previous content data is extracted from the previous content before decoding and is stored in the decoder storage unit 143 as the content data decoding information 143b while the previous content data is being output by the content outputting unit 300. Next, when a control signal for switching to new content is received from the control unit 400, the decoding information comparing unit 141b compares the decoding information 143b regarding the previous content data stored in the decoder storage unit 143 to decoding information regarding new content data that is extracted by the decoding information extracting unit 141a and may determine whether to stop and restart the decoder 140.

On the other hand, the decoding information 143b regarding previous content data stored in the decoder storage unit 143 is no longer necessary after being used by the decoding information comparing unit 141b for comparing decoding information, and thus the decoding information 143b may be deleted from the decoder storage unit 143. Then, the decoding information 143b regarding new content data may be stored in the decoder storage unit 143 and used for comparing decoding information during later content switching.

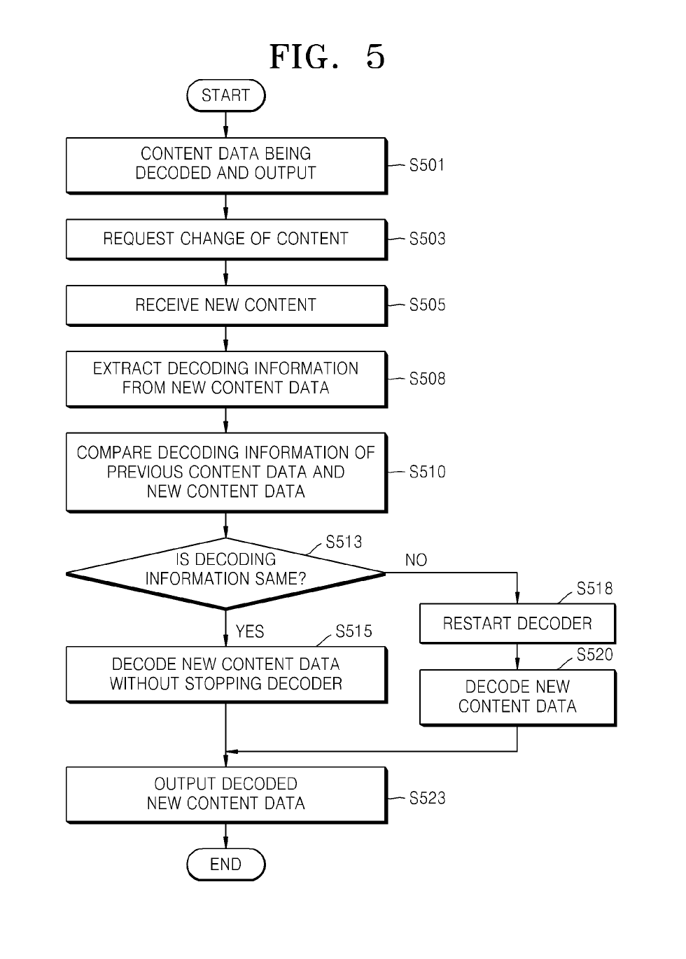

FIG. 5 is a flowchart of a method of decoding content data by using decoding information, according to an exemplary embodiment.

Referring to FIG. 5, while content data is decoded by the decoder 140 and is being output by the content outputting unit 300 (operation S501), the content processing unit 100 and the content receiving unit 200 receive a control signal for requesting a content switch from the control unit 400 (operation S503). The decoding information 143b of the content data that is currently being output may be extracted by the decoding information extracting unit 141a of the decoder 140 and stored in the decoder storage unit 143 as the decoding information 143b of the content data before the content data is decoded. Here, the control signal for requesting the content switch may be generated based on a user input signal or a user setting regarding content switch.

Furthermore, the content processing unit 100 further includes the first buffer 110 and the second buffer 130 for temporarily storing therein contents being received. When a control signal for requesting the content switch is received, the content processing unit 100 may delete previous content data stored in the first buffer 110 and the second buffer 130 to store new content.

The content receiving unit 200 receives new content via a broadcasting network or a communication network (operation S505), or stored locally, and transmits the new content to the content processing unit 100.

Here, the content processing unit 100 may further include the demuxer 120 to parse various types of content data from the received content and transmit the parsed content data to the decoder 140. Content data parsed by the demuxer 120 may be temporarily stored in the second buffer 130 and may be transmitted to the decoder 140 via the second buffer 130. Content data including various types of data parsed by the demuxer 120 may be decoded according to types of data. For example, multimedia data may be separated to audio data and video data and separately decoded by the decoder 140.

New content parsed by the content processing unit 100 is transmitted to the decoder 140, and decoding information regarding new content data decoder 140 is extracted by the decoding information extracting unit 141a before the new content data is decoded (operation S508). The extracted decoding information may be stored in the decoder storage unit 143 as the content data decoding information 143b and may be used for comparing decoding information in a case of switching to another content later.

When the decoding information comparing unit 141b compares decoding information of previous content data to decoding information of new content data (operation S510), if the decoding information of the previous content data is identical to the decoding information of the new content data (operation S513), the decoding control unit 141 decodes the new content data without restarting the decoder 140 (operation S515). However, if the decoding information of the previous content data is not identical to the decoding information of the new content data (operation S525), the decoding control unit 141 restarts the decoder 140 (operation 528) and decodes the new content (operation S528).

In terms of comparing the decoder information 143a, there may be cases in which it is not necessary to restart the decoder even if decoding information of new content data is not identical to decoding information of previous content data. Therefore, while decoding information of new content data is compared to decoding information of previous content data, the decoder 140 may refer to the decoder information 143a including a list of decoding information corresponding to cases where the decoder 140 is to be restarted if the decoding information of the new content data is not identical to the decoding information of the previous content data. Therefore, it is not necessary to compare all decoding information by using the decoder information 143a, and, even if decoding information of the new content data is partially identical to decoding information of the previous content data, it may not be necessary to restart the decoder 140. Therefore, a number of cases where the decoder 140 is to be restarted may be minimized. While the present exemplary embodiment is described with reference to a list of decoding information corresponding to cases where the decoder is to be restarted if the decoding information of the new content data is not identical to the decoding information of the previous content data, it is understood that another exemplary embodiment is not limited thereto. For example, the list of decoding information according to another exemplary embodiment may correspond to cases where the decoder is not to be restarted even if the decoding information of the new content data is not identical to the decoding information of the previous content data. Moreover, it is understood that the reference to the decoder information 143a may occur before or after the comparing of the decoding information.

Furthermore, after the decoding information comparing unit 141b compares decoding information (the operation S510), the decoding information 143b regarding previous content data stored in the decoder storage unit 143 is no longer necessary, and thus the decoding information 143b may be deleted from the decoder storage unit 143. Then, the decoding information 143b regarding new content data may be stored in the decoder storage unit 143 as the content data decoding information 143b.

Decoded content is transmitted to the content outputting unit 300 and is output via a display unit (operation S523).

According to the present exemplary embodiment, if decoding information of previous content data is identical to decoding information of new content data, a decoder is not restarted to decode the new content data, where decoding information is information used for decoding content data. As a result, a delay for switching content may be minimized, and thus new content may be quickly reproduced.

An exemplary embodiment can also be embodied as computer readable codes on a computer readable recording medium. The computer readable recording medium is any data storage device that can store programs or data which can be thereafter read by a computer system. Examples of the computer readable recording medium include read-only memory (ROM), random-access memory (RAM), CD-ROMs, magnetic tapes, hard disks, floppy disks, flash memory, optical data storage devices, and so on. Moreover, one or more units of the terminal device 1000 can include a processor or microprocessor executing a computer program stored in a computer-readable medium.

While exemplary embodiments have been particularly shown and described above, it will be understood by those of ordinary skill in the art that various changes in form and details may be made therein without departing from the spirit and scope of the present invention as defined by the following claims.

What is claimed is:

1. A method of decoding content data by using decoding information, the method comprising:
receiving a request to switch to an output of new content data;
extracting first decoding information from the new content data;
comparing the first decoding information of the new content data to second decoding information of previous content data; and
based on a result of the comparing the first decoding information of the new content data to the second decoding information of the previous content data, determining whether to restart a decoder.

2. The method of claim 1, further comprising receiving the new content data.

3. The method of claim 1, further comprising:
in response to the first decoding information of the new content data being identical to the second decoding information of the previous content data according to the comparing, decoding the new content data without restarting the decoder; and
in response to the first decoding information of the new content data not being identical to the second decoding information of the previous content data according to the comparing, decoding the new content data after stopping and restarting the decoder.

4. The method of claim 2, wherein the receiving the new content data comprises receiving the new content data after data stored in a buffer in relation to the previous content data is deleted.

5. The method of claim 1, wherein the comparing the first decoding information of the new content data to the second decoding information of the previous content data comprises comparing information used for comparing an identity of decoding information by which it is determined whether to stop the decoder for switching contents.

6. The method of claim 1, wherein the extracting the first decoding information of the new content data comprises, after the first decoding information of the new content data is extracted, storing the extracted first decoding information of the new content data.

7. The method of claim 6, wherein the comparing the first decoding information of the new content data to the second decoding information of the previous content data comprises, in a case of switching content, the first decoding information of the new content data is compared to the second decoding information of the previous content data that is stored in advance.

8. The method of claim 1, wherein the extracting the first decoding information of the new content data comprises:
extracting at least one type of content data from the new content data; and
extracting at least one decoding information per type of content data.

9. The method of claim 1, wherein the comparing the first decoding information of the new content data to the second decoding information of the previous content data comprises deleting the second decoding information of the previous content data after the first decoding information of the new content data is compared to the second decoding information of the previous content data.

10. The method of claim 1, wherein:
the comparing comprises determining whether the first decoding information of the new content data is included in a list of decoding information corresponding to cases where the decoder is to be restarted if not identical to the second decoding information of the previous content data; and
the determining whether to restart the decoder comprises determining not to restart the decoder in response to determining that the first decoding information of the new content data is not included in the list of decoding information.

11. The method of claim 1, wherein:
the comparing comprises:
determining whether the first decoding information of the new content data is included in a list of decoding information corresponding to cases where the decoder is to be restarted if not identical to the second decoding information of the previous content data,
comparing the first decoding information of the new content data to the second decoding information of the previous content data in response to determining that the first decoding information of the new content data is included in the list of decoding information, and
not comparing the first decoding information of the new content data to the second decoding information of the previous content data in response to determining that the first decoding information of the new content data is not included in the list of decoding information; and
the determining whether to restart the decoder comprises determining not to restart the decoder in response to determining that the first decoding information of the new content data is not included in the list of decoding information.

12. A computer readable recording medium having recorded thereon a computer program for implementing the method of claim 1.

13. A terminal device for decoding content data by using decoding information, the terminal device comprising:
a content processing unit which comprises a decoder for decoding content data, receives new content data according to a request for switching content, compares first decoding information of the new content data to second decoding information of previous content data, and, based on a result of the comparing, determines whether to restart the decoder; and
a content outputting unit which outputs the decoded content data.

14. The terminal device of claim 13, further comprising a content receiving unit which receives the new content data.

15. The terminal device of claim 13, wherein:
in response to the first decoding information of the new content data being identical to the second decoding information of the previous content data according to the comparing, the decoder decodes the new content data without being restarted; and
in response to the first decoding information of the new content data not being identical to the second decoding information of the previous content data according to the comparing, the decoder decodes the new content data after being stopped and restarted.

16. The terminal device of claim 13, wherein the decoder comprises:
a decoding control unit, comprising:
a decoding information extracting module which extracts the first decoding information from the new content data, and
a decoding information comparing module which compares the first decoding information of the new content data to the second decoding information of the previous content data; and
a decoding performing unit which performs the decoding of the content data.

17. The terminal device of claim 16, wherein:
the decoder further comprises a decoder storage unit which stores information used for comparing an identity of decoding information by which it is determined whether to stop and restart the decoder for switching contents; and
the decoding information comparing module compares decoding information comprising one or more information used for comparing an identity of decoding information by which it is determined whether to stop and restart the decoder for switching contents.

18. The terminal device of claim 16, wherein:
the decoder further comprises a decoder storage unit which stores the second decoding information of the previous content data; and
in a case of switching content, the decoding information comparing unit compares the first decoding information of the new content data to the second decoding information of the previous content data that is stored in advance.

19. The terminal device of claim 18, wherein the decoding control unit deletes the second decoding information of the previous content data after the first decoding information of the new content data is compared to the second decoding information of the previous content data.

20. The terminal device of claim 18, wherein, when the first decoding information of the new content data is extracted by the decoding information extracting module, the decoding control unit stores the first decoding information of the new content data in the decoder storage unit.

21. The terminal device of claim 14, wherein:
the content processing unit further comprises a buffer for temporarily storing content transmitted to the decoder;
data related to the previous content stored in the buffer is deleted in response to the request for switching content; and
the content receiving unit receives the new content.

22. The terminal device of claim 13, wherein:
the content processing unit further comprises a demuxer which categorizes content into various types of data; and
the decoder extracts at least one decoding information per type of data and compares the second decoding information of the previous content data to the first decoding information of the new content data.

23. A method of decoding content data by using decoding information, the method comprising:
comparing first decoding information corresponding to new content data to second decoding information corresponding to previous content data; and
based on a result of the comparing the first decoding information to the second decoding information, determining whether to restart a decoder when switching from an output of the previous content data to an output of the new content data.

24. A computer readable recording medium having recorded thereon a computer program for implementing the method of claim 23.
